(19) United States
(12) Patent Application Publication
(10) Pub. No.: US 2009/0065529 A1
(43) Pub. Date: Mar. 12, 2009

(54) POST-MIX BEVERAGE DISPENSING DEVICE

(75) Inventor: Riccardo Guadalupi, Zanica (IT)

Correspondence Address: LUCAS & MERCANTI, LLP, 475 PARK AVENUE SOUTH, 15TH FLOOR, NEW YORK, NY, 10016, US

(73) Assignee: VIN SERVICE S.R.L., Zanica (IT)

(21) Appl. No.: 12/278,448

(22) PCT Filed: Dec. 15, 2006
(86) PCT No.: PCT/IB2006/003636

§ 371 Date: Aug. 6, 2008

(30) Foreign Application Priority Data
Feb. 7, 2006 (IT) MI2006A000208

(51) Int. Cl. B67D 5/56

(52) U.S. Cl. 222/129.1; 137/7

(57) ABSTRACT

A post-mix beverage dispensing device of a type comprising at least two sources for the liquids to be mixed, which are fluidically communicated with at least two respective ducts, at least one delivery tap for a beverage, which is fluidically connected to said ducts, as well as for at least one of these ducts, means for adjusting the flow rate and/or pressure of the liquid, which are placed upstream of the delivery tap. The device also comprises, for each of these ducts, a bypass channel being provided with a relative plug, these bypass channels being provided with a respective outlet opening, which is placed downstream of the relative plug, and being interposed between the delivery tap and said means for adjusting the flow rate and/or pressure.

### FIELD OF THE INVENTION

The present invention relates to a post-mix beverage dispensing device, i.e. wherein at least two liquids making up the beverage to be dispensed are mixed, in a preset mutual volume ratio, only at the time when the beverage must be delivered into the final vessel.

### BACKGROUND ART

Post-mix beverage devices, such as known from British Patent No. 1911-003191 to FUCHS, usually comprise at least two reservoirs, or sources, which contain a diluent, such as water or soda, and a syrup, respectively, and at least two ducts connected to the two reservoirs and intended to convey said liquids to a delivery tap, in which these liquids are mixed at the time when the beverage is being dispensed into the final vessel.

Delivery taps that are currently provided in many beverage post-mix devices provide, particularly, that the mixing is carried out immediately downstream of the plug (or pin) of the delivery tap within a suitable shaped chamber in which the two liquids—up to that point still separated—are caused to mix according to a certain dynamic, such as by causing a liquid to rotate relative the other and/or by forcing at least one of the liquids to be fractioned into more fluid threads, such as to improve the mixing of the latter.

These devices are further normally provided with means for adjusting the flow rate (and/or pressure) of the liquid contained within at least one of said two ducts, such as to allow the mix volume ratio (the so-called “Brix”) of the two liquids to be changed at the time when they are being dispensed.

These flow rate adjusting means can, for example, consist of at least one on-off valve for the liquid, either manually or automatically operated, which is placed within one of the two ducts upstream of the delivery tap, and which is shaped such as to either reduce or increase the duct local section, thereby aiming at changing the flow rate of this liquid directed to the delivery tap.

In the quite common case in which all of the conveyor ducts for the liquids composing the beverage comprise a flow rate control valve, the operator, aiming at obtaining a certain mix ratio, which is usually preset by the beverage manufacturer, acts on said delivery valves until the preset flow rate is obtained, ex ante, for each liquid composing the beverage.

However, due to the thermodynamic variations in the liquids (mostly in the delivery temperature and pressure) that can occur in the dispensing device, the adjustment of the flow rate according to theoretic measures often does not result in the desired beverage mix ratio. Consequently, it is necessary to know the actual mix ratio of the beverage being delivered from the tap.

Naturally, when the actual mix ratio is known, it is sufficient to operate said flow rate (or pressure) adjusting means, and repeatedly measure this mix ratio, if required, in order to obtain the proper mix ratio at the delivery tap as desired.

To this purpose, it is known to apply a flow diverter immediately upstream of the region where the liquids are mixed, but downstream of the means for adjusting the flow-rate of the latter, which allows the liquids to be maintained separated from each other, and distributed within a suitable graduated vessel, usually having fluidically separated compartments, which visually provides the operator with the measure of the actual mix ratio of the beverage being delivered.

For example, in U.S. Pat. No. 4,293,008 to The Coca Cola co. a particular graduated vessel is described which, when placed below a suitable flow diverter being applied at the delivery tap of the post-mix beverage dispensing device, allows for a rapid reading of said mix ratio (Brix).

In greater detail, in U.S. Pat. No. 4,293,008, in a delivery tap of a type in which the liquids are mixed downstream of the plug thereof, a flow diverter, for example, of a type as described in U.S. Pat. No. 2,982,446 (Liolios) can be inserted, and that said graduated vessel for measuring the mix ratio is placed at the outlet openings of said diverter. Thereby, when the plug of the delivery tap is operated for opening, the liquids exiting therefrom are channelled by the flow diverter in a separate manner within the measurement vessel, which allows a prompt reading of the mix ratio.

U.S. Pat. No. 4,762,251, to Pepsico inc., describes a similar measuring vessel for evaluating a beverage mix ratio (Brix) and similar means for allowing the separate delivery of the liquids composing the beverage within the measuring vessel, from the delivery tap.

Using a measuring vessel for visually evaluating the actual mix ratio of a beverage in a post-mix dispensing device is certainly an effective, inexpensive and simple embodiment, even though the requirement of having to mount, sometimes in a quite complicated manner, an external flow diverter at the delivery tap, results to be a complicated and rather time-consuming operation.

Furthermore, the provision of objects separated from the post-mix beverage dispensing device, such as the flow diverter and measuring vessel, can entail logistic problems to the operator of the dispensing device, since these separated objects require to be carefully stored, when unused, in order to avoid losing or damaging the latter.

Finally, the flow diverter, which is fitted at the delivery tap, must be suitably sterilized and/or sanitized, together with the tap, both prior to and after each use, to prevent noxious organic residues from forming on the flow diverter or within the tap.

Alternatively to the visual detection of the beverage mix ratio, and the consequent manual (or assisted) adjustment of the flow rate of the liquids composing the beverage, post-mix beverage dispensing devices are also known in which suitable flow rate and/or pressure sensors, which are arranged downstream of the flow rate and/or pressure adjusting means and upstream of the delivery tap, are operatively connected to an automatic controller for said adjusting means, the latter being in this case automatically operated.

For example, U.S. Pat. No. 4,884,729, to The Coca Cola co., teaches to use flowmeters to control solenoid valves suitable for adjusting the flow rate of at least one of the liquids of the beverage. In greater detail, the output signals from the flowmeters, which are proportional to the measurement of the liquid flow, are sent to a microprocessor, which is then capable of controlling the opening or closure of the solenoid valves.

U.S. Pat. No. 6,845,886, to Henry et al., describes a post-mix beverage dispensing device, in which a flow sensor is provided for use within the diluent duct and a flow sensor and a pressure sensor are provided within the syrup duct. The output signals from said sensors are employed by a microprocessor which is capable of adjusting the outflow conditions of both the diluent and syrup, by acting on respective means for adjusting the flow rate and/or pressure.

The use of electrically-powered automatic devices for detecting and adjusting the actual mix ratio of the beverage being delivered usually entails obtaining beverages in an optimum mixture, regardless of the thermodynamic condition of the liquids composing the beverage.

However, using these automatic devices not only entails a considerable complexity in the manufacture of the beverage dispensing device, with consequent possible stops during the operation of the latter due to failure and/or maintenance, but also entails a constant electric power supply being provided for operating the device. In the event of electric power supply failure, the beverage dispensing device normally cannot be used, or however, it cannot measure or change the mix ratio of the liquids—diluent and syrup(s)—composing the beverage to be delivered.

It is accordingly an object of the present invention to provide a post-mix beverage dispensing device, which though being simple to manufacture, and thus allowing the visual measurement of the beverage mix ratio, does not suffer from the drawbacks typical of devices of this kind, as stated above.

Particularly, it is an object of the present invention to provide a post-mix beverage dispensing device which, though providing the non-automated measurement and adjustment of the beverage mix ratio, does not oblige the operator to fit an external flow diverter to the device at the delivery tap, with a consequent waste of time resources, and possible logistic and hygienic problems.

Another object of the present invention is to provide a post-mix beverage device which allows carrying out the measurement of the beverage mix ratio (Brix), in a rapid and efficient manner, without the required provision of an electric power supply.

A further object of the present invention is to provide a method for adjusting the beverage mix ratio, which results to be considerably practical and effective, using the device being the object of this invention.

### SUMMARY OF THE INVENTION

These and other objects are achieved by the post-mix beverage dispensing device according to the first independent claim, and the following claims depending thereon, as well as by the method for adjusting the mix ratio of a beverage being delivered by means of said device, according to the eleventh independent claim and the following claims depending thereon.

The post-mix beverage dispensing device according to the present invention comprises at least two sources for the liquids to be mixed, which usually consist of a diluent and a syrup, which are fluidically communicated with at least two respective ducts for these liquids, and at least one tap for delivering the beverage, which is fluidically connected to these ducts, as well as, for at least one of these ducts, means for adjusting the flow rate and/or pressure of the relative liquid that are placed upstream of said tap. The device further comprises, for each of the ducts, a bypass channel being provided with a relative plug and relative outlet opening that is placed downstream of said relative plug, these channels being interposed between the delivery tap and the means for adjusting the flow rate and/or pressure.

The provision of permanent bypass channels for the liquids to be mixed, which are preferably formed within the body of the beverage dispensing device, makes the provision and assembly of an external flow diverter no longer required for measuring the beverage mix ratio, thereby making said operations of measuring and adjusting the mixture by the operator very rapid and effective.

In fact, as provided by the method of the present invention for setting and adjusting the mix ratio of at least two liquids by means of a dispensing device of the type as claimed herein, the steps are only required of:
a. arranging a graduated vessel, of a type used for visually checking the mix ratio of at least two liquids, at the outlet openings of the bypass channels;
b. operating, either prior to or after said step of arranging a graduated vessel, the plugs of the bypass channels to open;
c. waiting for the graduated vessel to be filled as required, and then
d. calculating, by means of the graduated vessel, the mix ratio of the liquids to be mixed;
in order to be capable of adjusting said beverage mix ratio in an easy and optimum manner.

In addition to this simplicity and rapidity of measurement and adjustment, the device according to the present invention does not entail the use of expensive and complex electrically-powered automated devices, thus increasing the reliability of the device and the continuity of use of the latter, even in case of failure of power supply.

Finally, these bypass channels can also be employed for a rapid maintenance of the hydraulic circuit upstream of the respective plugs of these channels, for example by allowing detergent substances to be introduced and circulated, which may affect any plastic parts of the delivery tap only upstream of this tap.

It should be noted that, herein and below, by beverage “mix ratio” is meant that volume ratio of the liquids being simultaneously delivered and mixed, which are provided in the final vessel, which compose the beverage intended to be consumed. Usually, these liquids consist of a diluent, such as water, sparkling water, or soda, and a syrup, such as concentrated fruit juice, which, when they are blended at the delivery tap of the post-mix device, according to certain volume percentages, yield the final beverage.

It should be also noted that by the term “source” is generally meant any means from which a liquid flows, usually pressurized, such as a suitable storage container or a delivery network (or circuit) of a liquid (such as a municipal water supply).

According to a preferred aspect of the present invention, the post-mix beverage dispensing device provides the plugs of said bypass channels of liquids to be mixed are operated by an individual actuating stem, such as to allow these bypass channels to be simultaneously opened in a simple manner, and accordingly the proper outflow of the liquids from the outlet openings of these ducts.

According to another aspect of the present invention, the post-mix beverage dispensing device also comprises a graduated removable vessel, of a type to be used for the visual control of the mix ratio (Brix) of the final beverage, which is placed at said opening outlets of the bypass channels of the liquids to be mixed.

### BRIEF DESCRIPTION OF THE DRAWINGS

A particular embodiment of the post-mix beverage dispensing device according to the present invention will be now described by way of non-limiting example, with reference to the annexed figures, in which:

FIG. 1 is a side schematic view of a post-mix beverage dispensing device, according to a particular aspect of the present invention, in which only two liquids, a diluent and a syrup, are mixed at the delivery tap of the device;

FIG. 2 is a three-dimensional schematic exploded view of the device in FIG. 1;

FIG. 3 is a side sectional view of a part of the device in FIG. 1, upstream of the delivery tap;

FIG. 4 is a three-dimensional schematic enlarged view of a bypass channel for a liquid to be mixed of the device in FIG. 1;

FIG. 5 is a front sectional view of the bypass channels for the liquids to be mixed of the device of the preceding Figures; and

FIG. 6 is a three-dimensional view of the plugs of the bypass channels in FIGS. 4 and 5.

### DETAILED DESCRIPTION OF A PARTICULAR EMBODIMENT OF THE INVENTION

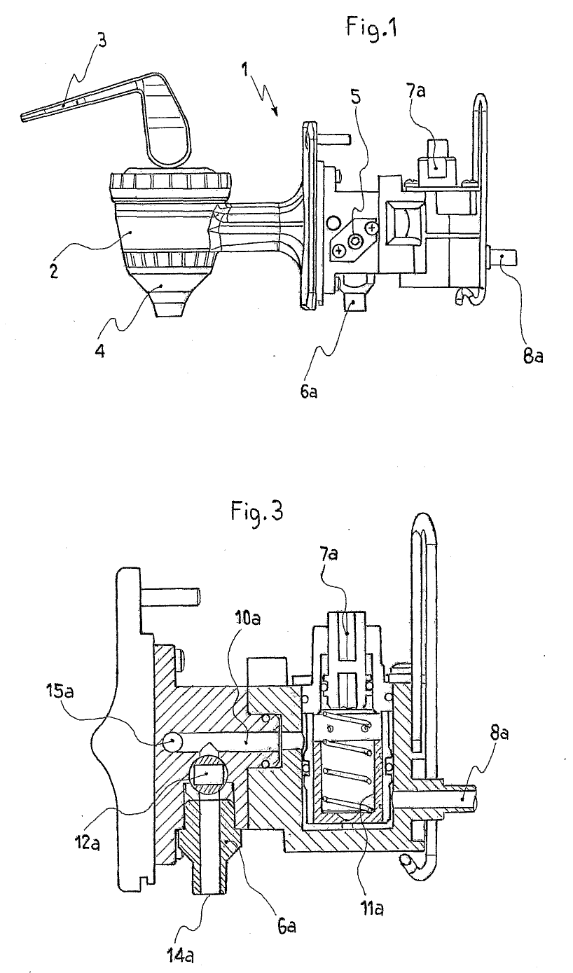

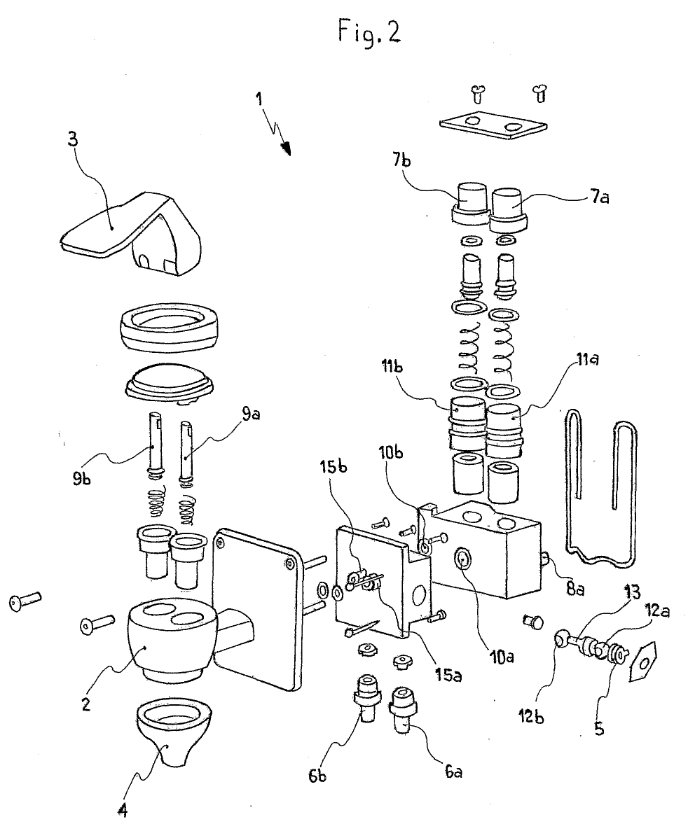

The particular post-mix beverage dispensing device 1 generally shown in FIGS. 1 and 2, according to a particular embodiment of the present invention, is of a type in which at least two liquids, a diluent and a syrup, are mixed to each other such as to form a beverage intended for consumption, at or proximate to a delivery tap 2, which is placed immediately upstream of an outlet spout 4 for the beverage.

Beverage delivery equipment currently available on the market usually comprise one or more of these post-mix beverage dispensing devices, in which the mixing of more liquids is not excluded (for example, a diluent and two or more syrups) for forming the final beverage, at said delivery tap.

In greater detail, as known in the art, in these dispensing devices 1 the diluent(s), such as water or carbonated water or soda, and the syrup(s), such as a concentrated fruit juice, are contained or fed, by relative containers or sources (not shown), which are usually refrigerated, and conveyed under pressure therefrom within separated ducts 8a, 10a, 10b, 15a, 15b to the delivery tap 2 of the device 1, where these liquids are mixed after the tap 2 has been opened.

In fact, as provided in the device 1 as illustrated herein, by opening said tap 2, for example by means of an operating knob 3 controlling two pins 9a, 9b, the ducts 10a, 15a; 10b, 15b conveying the diluent and syrup can be simultaneously opened, and these liquids are consequently fed to a suitable mixing chamber placed within the outlet spout 4 of tap 2.

The ratio at which the diluent and syrup are mixed within the mixing chamber of spout 4 to compose the desired beverage is given by the relative flow rates of diluent and syrup within tap 2, which can be adjusted, in the device 1 as illustrated herein by suitable means 7a, 7b, 11a, 11b for adjusting the flow rate and/or pressure of the liquid, which are placed within said conveyor ducts 8a, 10a, 10b of the liquids to be mixed, upstream of the delivery tap 2.

These adjusting means, for example consisting of on-off valves of the liquid being provided with shutters 11a, 11b and control knobs 7a, 7b placed within these ducts 8a, 10a, 10b, 15a, 15b have the purpose of allowing a manual (or optionally a semi-automated or automated) variation in the flow rate of the flow directed to the tap 2, for example by means of variations in the passage section of the relative ducts 10a, 10b.

It should be observed that any other known means for adjusting the flow rate (or pressure) of a liquid within a duct can be alternatively used within said ducts 10a, 10b, upstream of the tap 2, in order to adjust the flow of the diluent and/or syrup that are directed to the latter, without thereby departing from the scope of protection of the present invention.

Furthermore, while in the beverage dispensing device 1, as illustrated in the annexed drawings, means 7a, 7b, 11a, 11b are provided for adjusting the liquids to be mixed in each duct 10a, 10b, the use of these means can be however provided only in some of these ducts, for example by leaving the flow of diluent (or syrup) uncontrolled.

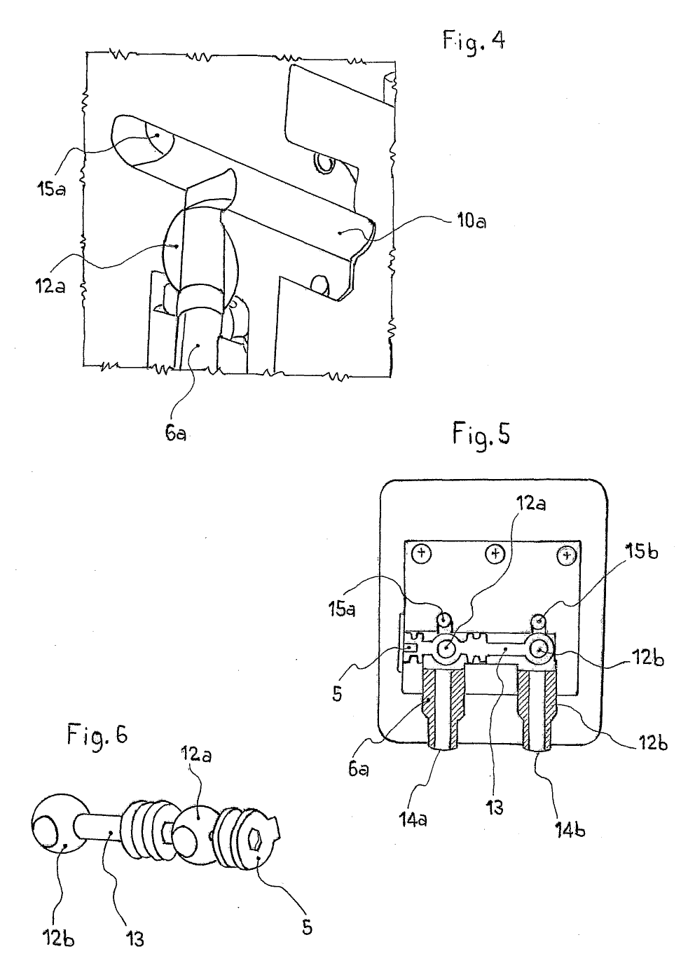

According to the present invention, advantageously, the post-mix beverage dispensing device 1 as illustrated herein (also with reference to FIG. 3-6) also comprises, for each conveyor duct 10a, 10b, 15a, 15b for the liquids to be mixed, a bypass channel 6a, 6b that is fluidically connected to the relative conveyor duct 10a, 10b, 15a, 15b by means of the interposition of a plug 12a, 12b suitable to allow the opening or closure of the channel 6a, 6b thereof, i.e. the inflow of the liquid provided within the duct 10a or 10b within the bypass channel 6a, 6b thereof.

These bypass channels 6a, 6b are formed within the body of the device 1, downstream of said means for adjusting the flow rate (and/or pressure) 7a, 7b, 11a, 11b of the liquids to be mixed, and upstream of the delivery tap 2 of the beverage dispensing device 1.

Each bypass channel 6a, 6b is further provided with an outlet opening 14a, 14b, which is obviously placed upstream of the relative plug 12a, 12b, which can allow filling a suitable graduated vessel (not shown), preferably removable, of a type to be used for visually check the beverage mix ratio, or can allow emptying the circuits upstream of the plug 12a, 12b of the liquids to be mixed, without requiring to open the delivery tap 2 of the dispensing device 1.

The plugs 12a, 12b of the bypass channels 6a, 6b can be automatically operated, or preferably, manually operated, and can allow diverting the whole liquid flow directed to the tap 2, towards the channels 6a, 6b, thus preventing the liquid from reaching the duct tract 15a, 15b (see FIG. 2-5) that is placed between each plug 12a, 12b and the tap 2, or they can allow diverting, according to the same proportion, only a part of the flow within the ducts 10a, 10b, or still they can simply allow the liquid inflow within said channels 6a, 6b, without thereby preventing the liquids from flowing to the tap 2.

The latter solution is considerably practical, since it allows the device 1 to operate also during the measurement of the mix ratio, is that preferably implemented in the embodiment of the invention as illustrated herein.

In the case where the device 1 provides a removable graduated vessel to be provided for visually checking the beverage mix ratio, this vessel may be, such as those described in said U.S. Pat. No. 4,293,008 or U.S. Pat. No. 4,762,251, of a type with separated compartments, which are placed at the outlet openings 14a, 14b of the bypass channels 6a, 6b of the device 1, respectively, such as to allow the graduated vessel to be properly filled with the diluent and syrup (and/or any other liquids to be mixed).

When graduated vessels are used for measuring the beverage mix ratio which are placed at the outlet openings 14a, 14b of the bypass channels 6a, 6b, the liquids flowing out of the channels 6a, 6b are required to simultaneously exit at the same flow rate, or a flow rate strictly proportional to that at which they would exit the tap 2. Therefore, according to a preferred aspect of the present invention, the plugs 12a, 12b can be mounted to an individual operating stem 13 and not only have the same size, but also the same position of opening of the channels 6a, 6b, relative to a fixed datum (i.e. reference) system.

This operating stem 13 can further end with a grip element 5 for the operator, or in the case of automated operation of the plugs 12a, 12b, with a fitting element for an actuator, such as an electromechanical actuator.

In greater detail, such as shown in FIG. 3 to 6, in the particular embodiment of the device 1 of the present invention as illustrated herein, the plugs 12a, 12b are of a two-way ball type. The angular position of the latter relative to the corresponding ducts 10a, 10b, and thus to the corresponding bypass channels 6a, 6b, determines the inflow of the respective liquid (diluent or syrup) within the channels 6a, 6b. Therefore, the rotation of the operating stem 13 in either way causes the liquids to be mixed to flow out of, alternatively, only the outlet spout 4, when the tap 2 is open (i.e. when the pins 9a, 9b are arranged such as to allow the liquids to flow out of the ducts 10a, 15a; 10b, 15b), or out of the outlet spout 4 (provided that the tap 2 is open) and simultaneously out of the outlet openings 14a, 14b of the bypass channels 6a, 6b.

It should be noted that, alternatively to the use of two-way ball plugs 12a, 12b (i.e. with a T-shaped hole) one-way ball plugs can be used with an L-shaped hole which allow, rather than prevent, the liquid to flow into the tap 2 when the liquid is allowed to flow within the bypass channels 6a, 6b and that, vice versa, prevent the liquids from flowing to said channels 6a, 6b when the liquids are instead allowed to flow to the tap 2.

In the embodiment as shown herein, furthermore, the grip element 5 of the operating stem 13 is provided with a shaped head for engaging in a corresponding moving tool (such as a screwdriver, in the case where the actuator provided for the stem 13 is being rotated), such as to prevent the stem 13 and accordingly the plugs 12a and 12b from being inadvertedly displaced, during the normal activity of the dispensing device 1.

While one plug 12a, 12b for each bypass channel 6a, 6b of a ball type, or however of a rotatably operated type has been described herein above, those skilled in the art will appreciate that other types of plugs can be alternatively used for the bypass channels 6a, 6b, for example of a shutter type with sliding operation, without thereby departing from the inventive concept of the present invention.

Similarly, while the provision of bypass channels 6a, 6b provided with outlet openings 14a, 14b has been described herein above, when required by the structure of the device 1, these bypass channels 6a, 6b may have a very reduced length, until they substantially coincide with bypass openings formed within the conveyor ducts 10a, 10b for the liquids to be mixed, to which said plugs are associated 12a, 12b. In this case, not illustrated herein, the channels 6a, 6b would substantially coincide with the above-described outlet openings 14a, 14b and said bypass openings provided within said ducts 10a, 10b.

As stated above, due to the provision of the bypass channels, 6a, 6b, that can be selectively opened by means of the plugs 12a, 12b, the adjustment of the mix ratio of the liquids found in the beverage destined to be dispensed results to be simplified and very effective.

In fact, due to the device 1 of the present invention, the mix ratio of the liquids composing the beverage, for example a diluent and a syrup, can be adjusted, by means of the following method which provides the steps of:
a) arranging a graduated vessel, preferably removable, of a type to be used for visually checking the mix ratio of at least two liquids, at the outlet openings 14a, 14b of the bypass channels 6a, 6b of the dispensing device 1;
b) operating the plugs 12a, 12b of the bypass channels 6a, 6b to open, such as to allow the liquids to be mixed to flow therein only through the outlet openings 14a, 14b of the channels 6a, 6b. When the device 1 as illustrated in FIG. 1-6 is used, the operator, by means of a suitable tool to be engaged in the shaped head 5 of the operating stem 13, for operating the plugs 12a, 12b to open should rotate this stem 13 until the plugs 12a, 12b result to be simultaneously arranged in their angular opening position of the channels 6a, 6b;
c) waiting for the graduated vessel to be filled as foreseen; and then preferably operating the plugs 12a, 12b to close, or moving the graduated vessel such that the latter does not intercept the liquids exiting the openings 14a, 14b any longer;
d) calculating by means of the graduated vessel, a measure of the mix ratio of the liquids in the beverage being delivered.

It should be observed that the steps a) and b) as described above can be chronologically exchanged without thereby affecting the result of the method as claimed herein, i.e. based on the beverage mix ratio.

Starting from this measure, the method can preferably provide the adjustment of one or more of the mixed liquids, by operating the relative means for adjusting the flow rate and/or pressure of the liquid. When the device 1 is used as described above, and thus the adjusting means being provided are of a manual type, the latter step of the method according to the present invention can provide that, when the actual mix ratio is other than required, the operator can act on the control knobs 7a, 7b such as to change, by means of the shutters 11a, 11b, the flow rate of both liquids (diluent and syrup, in this case) that are directed, within the ducts 10a, 10b, to the delivery tap 2.

The subsequent repetition of the steps intended to obtain the measurement of the mix ratio and the following adjustment of the flow rates of the liquids as described above allows a fine adjustment of this mix ratio until the optimum beverage mix ratio is obtained.

1. A post-mix beverage dispensing device, of a type comprising at least two sources of the liquids to be mixed, which are fluidically communicated with at least two respective ducts for said liquids to be mixed, at least one delivery tap of a beverage, that is fluidically connected to said at least two ducts, as well as, for at least one of said at least two ducts, means for adjusting the flow rate and/or pressure of the liquid which are placed upstream of said at least one delivery tap, characterized in that it comprises, for each of said at least two ducts, a bypass channel being provided with a relative plug, said bypass channels being provided with a respective outlet opening being placed downstream of said relative plug, and being interposed between said at least one delivery tap and said means for adjusting the flow rate and/or pressure.

2. The device according to claim 1, characterized in that said plug is manually operated.

3. The device according to claim 1, characterized in that it comprises an individual operating stem for said plugs of said at least two ducts for the liquids to be mixed.

4. The device according to claim 3, wherein said plugs have the same position, relative to any fixed, datum, of opening of said bypass channels.

5. The device according to claim 1, characterized in that said plug is of a ball type, either one-way or two-way.

6. The device according to claim 1, characterized in that the operating stem of said plugs is provided with a shaped head for engagement with a rotating tool.

7. The device according to claim 1, characterized in that it comprises a removable graduated vessel, of a type to be used for visually checking the mix ratio of at least two liquids, which is placed at said outlet openings of said bypass channels.

8. The device according to claim 7, characterized in that said vessel comprises at least two fluidically separated compartments that are placed at said outlet openings of said bypass channels, respectively.

9. The device according to claim 1, characterized in that at least one of said bypass channels coincides with the relative outlet opening.

10. The device according to claim 1, characterized in that all the ducts for said liquids to be mixed are provided with said means for adjusting the flow rate and/or pressure of the liquid.

11. A method for determining and adjusting the mix ratio of at least two liquids in a beverage delivery equipment being provided with at least one post-mix dispensing device according to any preceding claim, characterized by the steps of:
a. placing a graduated vessel, of a type used for visually checking the mix ratio of at least two liquids, at the outlet openings of said bypass channels;
b. prior to or after said step of arranging a graduated vessel, operating said plugs of said bypass channels to open;
c. waiting for said graduated vessel to be filled as desired; then
d. calculating, by means of said graduated vessel, the mix ratio of said at least two liquids.

12. The method according to claim 11, characterized in that it comprises a further step of adjusting the flow rate and/or pressure of at least one of said at least two liquids by operating said adjusting means.

13. The method according to claim 11, wherein a step of operating said plugs to close is provided either prior to or after said step of calculating the mix ratio.

14. The method according to claim 11 characterized in that the steps claimed herein are repeated several times until the beverage mix ratio has been reached as desired.
